(19) United States
(12) Patent Application Publication
(10) Pub. No.: US 2011/0117974 A1
(43) Pub. Date: May 19, 2011

(54) SUPPLEMENTAL ACCESSORY SYSTEM FOR PORTABLE ELECTRONIC DEVICES

(76) Inventors: Landon Spitalnik, South Bend, IN (US); James Ladas, Austin, TX (US)

(21) Appl. No.: 12/988,948

(22) PCT Filed: Apr. 20, 2009
(86) PCT No.: PCT/US09/41135

§ 371 Date: Jan. 4, 2011

Related U.S. Application Data
(60) Provisional application No. 61/047,603, filed on Apr. 24, 2008.

(51) Int. Cl. H02J 7/00

(52) U.S. Cl. 455/573; 455/572

(57) ABSTRACT

Examples of the present invention are directed toward systems and methods of providing additional functionality to a portable electro device Examples of such systems include a terminal adapter having a first portion constructed and arranged to connect to the portable electronic device by insertion between a terminal of a battery of the portable electronic device and a power terminal of the portable electronic device and an accessory module constructed and arranged to electrically couple to the portable electronic device through least one terminal on a second portion of the terminal adapter to provide supplemental power to the portable electronic device. Examples of methods according to the present invention include mounting a terminal adapter comprising a positive contact and a negative contact, and a set of electrical terminals a battery of the portable electronic device.

### RELATED APPLICATIONS

This application claims priority to U.S. Provisional Application Ser. No. 61/047,603, entitled “SUPPLEMENTAL ACCESSORY SYSTEM FOR PORTABLE ELECTRONIC DEVICES,” filed on Apr. 24, 2008, which is herein incorporated by reference in its entirety.

### BACKGROUND OF INVENTION

1. Field of Invention

Embodiments of the present invention are directed toward apparatus and methods of providing supplemental accessory elements to impart additional functionality to portable electronic devices.

2. Discussion of Related Art

Many portable electronic devices such as cellular telephones, smart phones, CD players, radios, MP3 players, computers, and video cameras need electrical power to operate. These devices are often equipped with portable batteries that store and supply electricity to the respective portable electronic devices. These batteries have finite capacity and must be replaced or recharged periodically. Recharging may be accomplished by connecting a rechargeable battery to another power source, for example an electrical grid or utility line, by means of a charging adapter. Charging adapters for different portable electronic devices are often specific to a particular device and capable of charging only that device.

The battery packs of portable electronic devices may become discharged over time as a device is used or may self-discharge over time. If a user has no replacement battery or charger on hand at the time that the battery becomes discharged, the device cannot be used until a replacement battery or a charger is obtained.

### SUMMARY OF INVENTION

According to an example of the present invention, there is provided a system for providing additional functionality to a portable electronic device. The system comprises a terminal adapter having a first portion constructed and arranged to connect to the portable electronic device by insertion between a terminal of a battery of the portable electronic device and a power terminal of the portable electronic device and an accessory module constructed and arranged to electrically couple to the portable electronic device through at least one terminal on a second portion of the terminal adapter.

According to another example of the present invention there is provided a system for providing supplemental power to a portable electronic device. The system comprises a terminal adapter and a power generation device in electrical communication with the terminal adapter, wherein the terminal adapter is in electrical communication with terminals of a battery of the portable electronic device and with power terminals of the portable electronic device, wherein the terminal adapter is mounted on the battery of the portable electronic device and enclosed in a battery compartment of the portable electronic device, and wherein the power generation device is external to the battery compartment of the portable electronic device.

According to a further example of the present invention there is provided a method of providing supplemental power to a portable electronic device. The method comprises mounting a terminal adapter comprising an outward facing positive terminal and an outward facing negative terminal, a first set of electrical terminals, and a second set of electrical terminals to a battery of the portable electronic device, wherein the first set of electrical terminals of the terminal adapter makes electrical contact with power terminals of the battery, installing the battery into a battery compartment of the portable electronic device, wherein the second set of electrical terminals of the terminal adapter make electrical contact with power terminals of the portable electronic device, and mounting a battery cover comprising a power generator and positive and negative electrical contacts on the battery compartment of the portable electronic device, the positive and negative electrical contacts of the battery cover making electrical contact with the outward facing positive and negative terminals of the terminal adapter.

According to another example of the present invention there is provided an apparatus for facilitating electrical connection of an accessory with a portable electronic device. The device comprises a substrate, a first surface comprising a plurality of power contacts, a second surface comprising a positive electrical contact and a negative electrical contact and an electrical conductor bound to the substrate and electrically connecting the positive electrical contact to at least one of the plurality of power contacts and electrically connecting the negative electrical contact to at least one other of the plurality of power contacts.

According to a further example of the present invention there is provided an apparatus for providing supplemental power to a portable electronic device. The apparatus comprises a flexible substrate, the substrate comprising an adhesive layer on a first side of the substrate and a flexible power generation device joined to a second side of the substrate, the flexible power generator in electrical communication with a mini-USB cable.

According to a further example of the present invention there is provided an apparatus for providing supplemental power to a portable electronic device. The apparatus comprises a body, a solar cell mounted to the body, and an electrical circuit electrically connecting the solar cell to an electrical contact, the electrical contact configured to electrically connect to a power terminal of the portable electronic device, wherein the body includes a plurality of portions which when joined together define a cavity configured to secure the portable electronic device, and wherein the body defines a hole through which a control of the portable electronic device is accessible.

### BRIEF DESCRIPTION OF DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by references signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 is an exploded view of the component pieces of an example of the present invention;

FIG. 2A is an alternate exploded view of the component pieces of an example of the present invention;

FIG. 2B is a perspective view of a front side of the device of FIG. 2A as assembled;

FIG. 3 is a perspective view of a battery compartment of a representative portable electronic device;

FIG. 4 is a perspective view of a battery of a representative portable electronic device;

FIG. 5 is a perspective view of a terminal adapter according to an example of the present invention;

FIG. 6 is an alternate perspective view of a terminal adapter according to an example of the present invention;

FIG. 7 is a perspective view from the top of an alternative power source module according to an example of the present invention;

FIG. 8 is a perspective view from the bottom of an alternative power source module according to an example of the present invention;

FIG. 9 is a perspective view of an alternative power source module in electrical communication with a terminal adapter according to an example of the present invention;

FIG. 10 is a perspective view from the rear of a portable electronic device coupled with an alternative power source module and a terminal adapter according to an example of the present invention;

FIG. 11 is a circuit diagram of a system according to an example of the present invention;

FIG. 12 is a top perspective view of an alternate power source module according to another example of the present invention;

FIG. 13 is a diagram of the terminals of a mini-USB connector utilized in some examples of the present invention;

FIG. 14 is a perspective view of an alternative power source module according to a further example of the present invention;

FIG. 15 is an exploded view of the component pieces of an alternate example of the present invention;

FIG. 16 is a rear side isometric view of an alternate example of the present invention;

FIG. 17 is a front side isometric view of the example of FIG. 16 with an example portable electronic device enclosed;

FIG. 18 is an exploded view of the component pieces of the example of FIGS. 16 and 17;

FIG. 19 is a cut-away perspective view of an example of the present invention including an example of an energy storage device;

FIG. 20 is a cut-away perspective view of an example of the present invention including a further example of an energy storage device;

FIG. 21 is a cut-away perspective view of an example of the present invention including a further example of an energy storage device;

FIG. 22 is a cut-away perspective view of an example of the present invention including a further example of an energy storage device; and

FIG. 23 is a cut-away perspective view of an example of the present invention including a further example of an energy storage device.

### DETAILED DESCRIPTION

Embodiments of the current invention are directed toward apparatus and methods of providing additional functionality to a portable electronic device, including providing an alternative power source for a portable electronic device. The term “portable electronic device” is to be understood to encompass devices including, but not limited to, cell phones, smart phones, pagers, radios or other music players, portable computers, video players, portable digital assistants (PDAs), garage door openers, remote controls, or other portable electronic devices that would be recognized as such by one of ordinary skill in the art.

It is to be appreciated that embodiments of the methods and apparatus discussed herein are not limited in application to the details of construction and the arrangement of components set forth in the following description or illustrated in the accompanying figures. The methods and apparatus are capable of implementation in other examples and of being practiced or of being carried out in various ways. Examples of specific implementations are provided herein for illustrative purposes only and are not intended to be limiting. In particular, acts, elements and features discussed in connection with any one or more examples are not intended to be excluded from a similar role in any other examples.

Also, the phraseology and terminology used herein is for the purpose of description and should not be regarded as limiting. Any references to examples or elements or acts of the systems and methods herein referred to in the singular may also embrace examples including a plurality of these elements, and any references in plural to any example or element or act herein may also embrace examples including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, and upper and lower are intended for convenience of description, not to limit the present systems and methods or their components to any one positional or spatial orientation.

Some examples of devices according to the present invention comprise circuitry that facilitates fitting a portable electronic device with one or more accessory modules, for example, an alternative power source, without materially changing the shape or function of the original electronic device. In some examples, the alternative power source is fitted on a portable electronic device to replace the battery cover of the original device and is capable of supplying power to the original portable electronic device. Power is generated by the alternative power source, in some examples, in the form of electrical power by converting light energy into electrical energy. In some examples, power is also stored by the alternative power source. Alternative power source generating technologies utilized by examples of the present invention include, but are not limited to: photovoltaics (solar cells), wind turbines, electromagnetic generators, electromechanical or dynamo type generators, fuel cells, and high frequency electrical transmission capture devices capable of drawing useful energy from, for example, ambient radio waves or microwaves. In some examples, the alternative power source also contains a direct current battery and/or capacitor that supplements the storage capacity of an original battery in a portable electronic device. In other embodiments, this battery or capacitor may facilitate a smoothing out of a level of power delivered by an alternative power source in the case that, for example, an energy source utilized by the alternative power source is intermittently available. This capacitor or battery may be charged by the alternative power source and/or a separate electrical input and/or by a battery charger for use with the original portable electronic device. The integrated power generation provided by some examples of the present invention frees the user from having to attach or tether their electronic device with cables, cords, and/or additional charging adapters to a conventional electricity source such as a utility grid.

An example of the present invention comprises an alternative power source and a coupling system for coupling the alternative power source to a portable electronic device. In one example, the alternative power source component is similar in form and shape to an original battery cover of the portable electronic device. In one example, the alternative power source generates electricity from an integrated photovoltaic panel. Light that the photovoltaic panel uses to produce electricity is provided from readily available sources such as the sun or artificial light fixtures. Circuitry including al blocking diode component and voltage and current management circuitry is integrated into the alternative power supply to control the direction, current, and voltage of electricity transmitted from the alternative power supply.

In one example, a coupling system comprises an electrical device that connects the electrical circuitry of a portable electronic device to the alternative power source. The electrical device comprises a terminal adapter component including electrical conductors and terminals. In some examples, the terminal adapter component is configured to be installed into the portable electronic device. When the portable electronic device is assembled, and the terminal adapter component is installed, the terminal adapter component connects the electrical circuitry of the portable electronic device to the circuitry of the alternative power source. In some examples, the terminal adapter and the alternative power source may be provided as a retrofit kit for a portable electronic device. The terminal adapter component is fabricated to fit the specific shape and conform to the particular electronic configuration of the portable electronic device, as well as the alternative power source, and is fitted as an intermediary between the battery and the power terminals of the portable electronic device. In some examples, electrical terminals of the terminal adapter are sandwiched between the electrical terminals of a battery and the electrical power terminals of a portable electronic device into which the battery is installed. In one example, the terminal adapter component is formed from a flexible plastic material. The terminal adapter comprises circuitry which, in use, electrically connects power terminals of the portable electronic device to electrical terminals of the alternative power source module. In one example, the terminal adapter component comprises a plastic film substrate that is molded to fit and contact the battery of the portable electronic device on an upper side, a lower side, and a power terminal end side.

In alternate examples, the alternative power source may comprise any one or combination of power generation or power conversion devices. One suitable device includes a photovoltaic solar panel component integrated into the housing of the alternative power supply and situated such that solar cells face away from the body of the device and are able to convert available light into electrical current. Another suitable device includes a mechanical electricity generator with, in some examples, an attached hand operated crank component integrated into the housing of the alternative power supply situated such that manual manipulation of the generator hand crank produces electric current. Another suitable device includes a mechanical dynamo electricity generator with, in some examples, an attached squeeze lever component integrated into the housing of the alternative power supply situated such that manual manipulation of the squeeze lever produces electric current. Another suitable device includes a mechanical electricity generator with attached wind driven turbine component integrated into the housing of the alternative power supply situated such that rotation of the wind turbine produces electric current. Another suitable device includes a kinetic electricity generator component integrated into the housing of the alternative power supply situated such that movement and/or vibration of the device produces electric current. Another suitable device includes a fuel cell component integrated into the housing of the alternative power supply that converts fuel such as methane, hydrogen, or ethanol into electric current. The above examples are not intended to be limiting. Alternative power sources used in examples of the present invention may include other power generating components known in the art. Another suitable device includes a power storage device (for example, a battery or a capacitor or other energy storage device) integrated into the housing of the alternative power supply that may store electrical energy and/or transmit electricity to a portable electronic device.

In some examples, several accessory modules or alternative power sources may be interchangeably coupled to a portable electronic device through the same terminal adapter component.

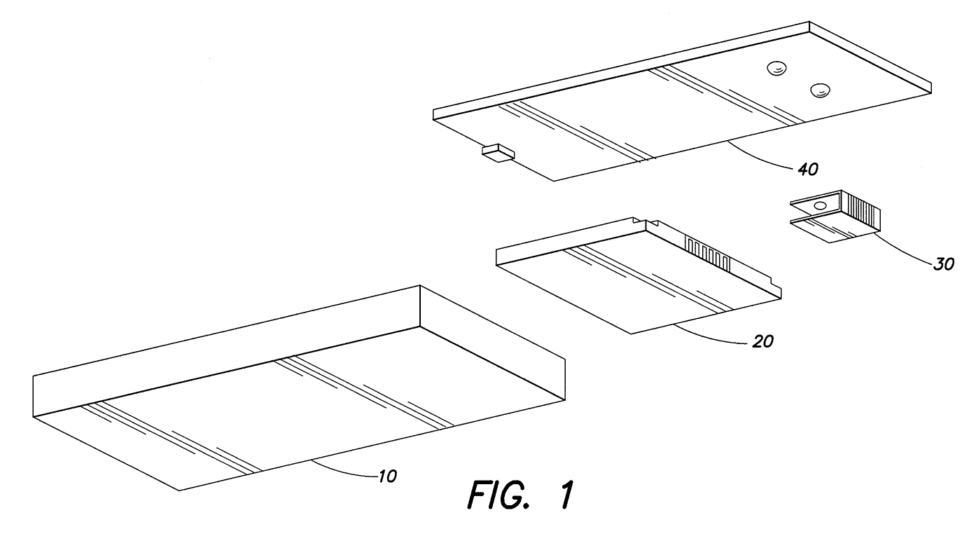

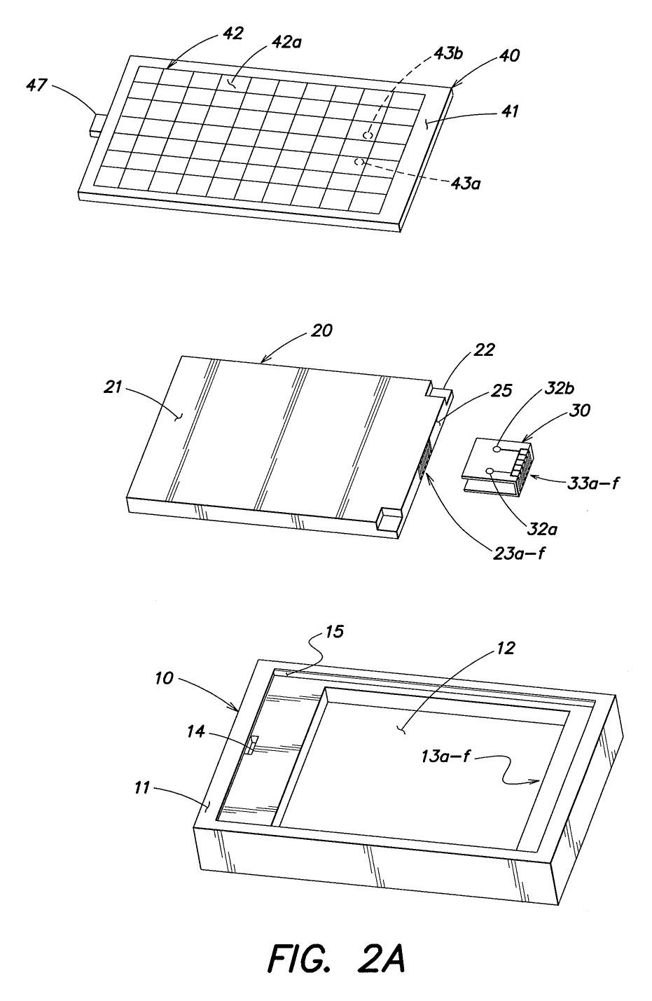

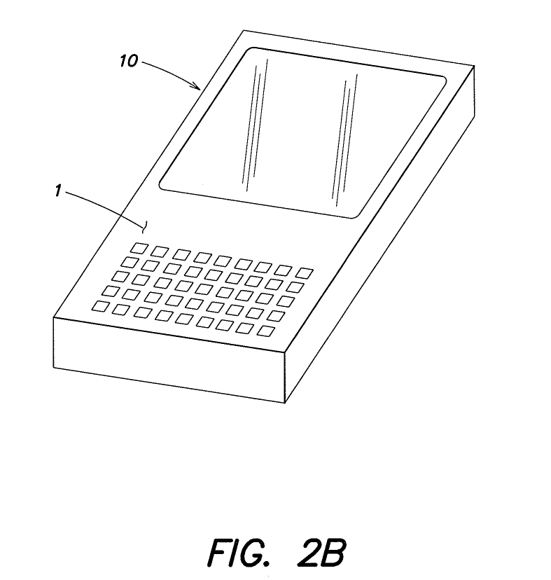

FIGS. 1, 2A, and 2B illustrate component parts of a system according to examples of the present invention. Illustrated in FIGS. 1, 2A, and 2B are a terminal adapter 30 and an alternative power source module 40, in conjunction with a portable electronic device 10 and a battery 20 therefore. The portable electronic device 10 has a front side 1 and a rear side 11. The rear side of the portable electronic device 10 includes a battery compartment 12 into which the battery 20 may be placed such that a battery terminal section on a power terminal end side 25 of battery 20 makes electrical contact with a battery contact section, including, for example, electrical terminals 13a-f, of the portable electronic device to provide power to the portable electronic device 10. In some embodiments, the portable electronic device 10 also includes a battery cover (not shown). In some examples, the alternative power source module 40 may replace a battery cover of the portable electronic device 10. The shape of the portable electronic device 10 illustrated is not meant to be limiting. In some examples, the portable electronic device is differently shaped than as illustrated in the Figures. For example, some examples of a portable electronic device 10 include corners that are substantially more rounded than are illustrated.

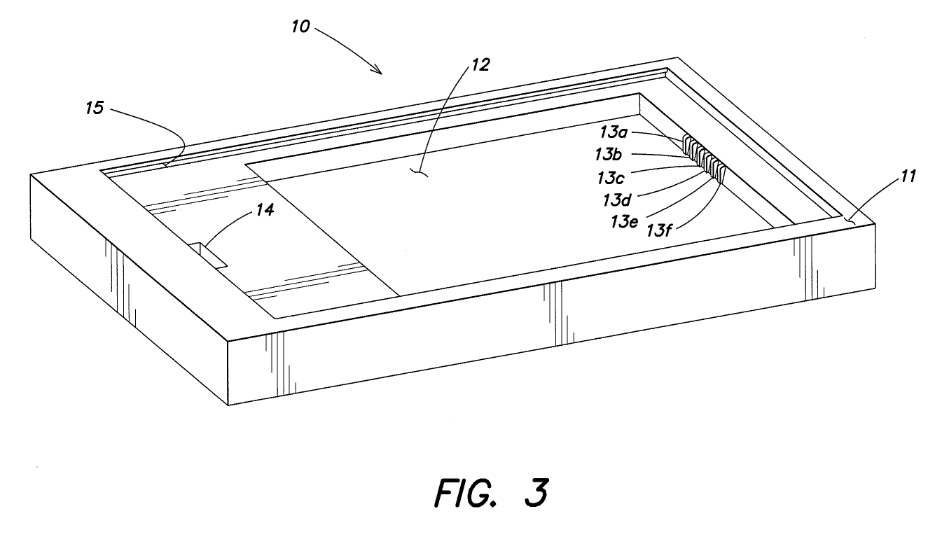

FIG. 3 is an enlarged view of the rear of a representative portable electronic device 10, illustrating the battery compartment 12 in detail. The battery compartment 12 includes a plurality of electrical contacts 13a-13f which in use, make electrical contact with corresponding power terminals of the battery 20. Different portable electronic devices may have more or fewer electrical contacts than are illustrated here. Different portable electronic devices may have electrical contacts or connectors located in different positions than are illustrated here. The rear of the portable electronic device 10 includes a recess 14 into which a tab of a battery cover may fit to facilitate securing the battery cover to the portable electronic device. Not all portable electronic devices include such a recess 14.

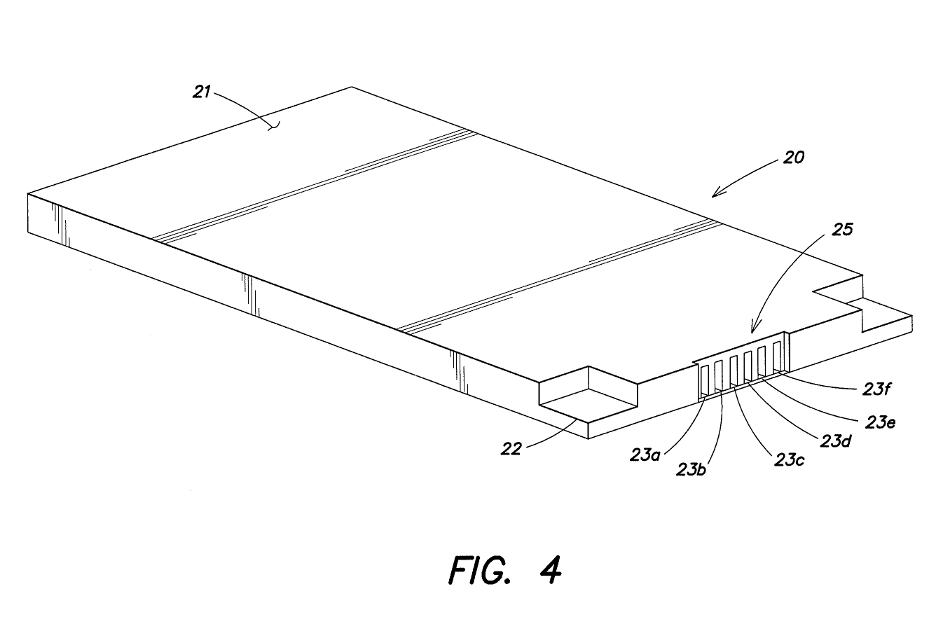

FIG. 4 is a detailed view of a battery 20 of an example portable electronic device 10. The battery 20 includes power terminals 23a-23f which in use make electrical contact with the contacts 13a-13f of the portable electronic device 10 to provide power to portable electronic device 10. Power terminals 23a-23f are in some examples recessed into the battery surface as illustrated, but in other examples are flush with the battery surface, and in further examples extend outward from the battery surface. The battery 20 also includes recessed areas 22 which prevent the battery 20 from being inserted into the battery compartment 12 incorrectly. Some examples of battery 20 have power terminals which are differently sized than those illustrated. Different batteries may have more or fewer power terminals than are illustrated here. Different batteries may have power terminals located in different positions than are illustrated here. Some batteries may not include the recessed areas 22.

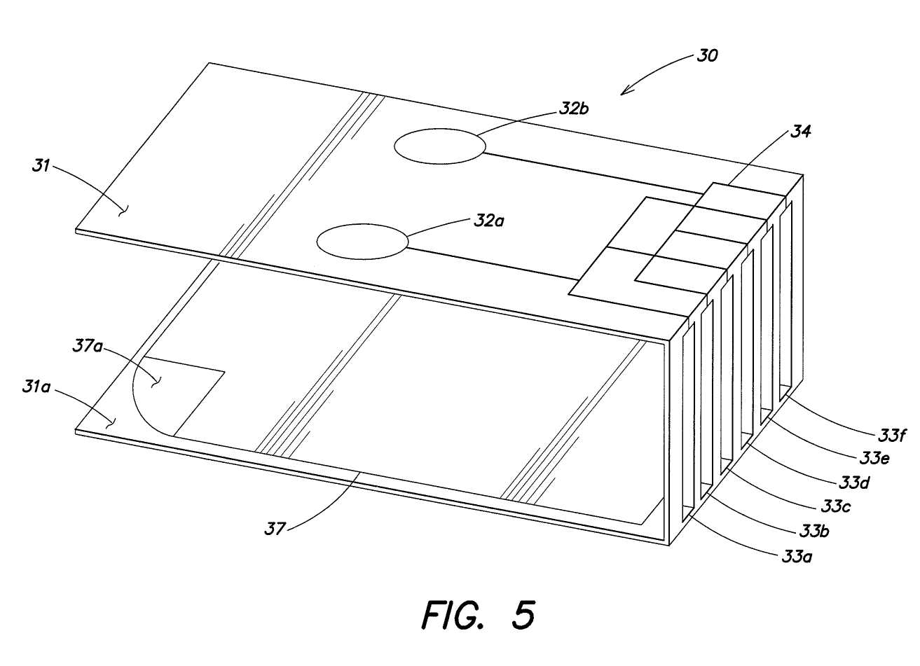

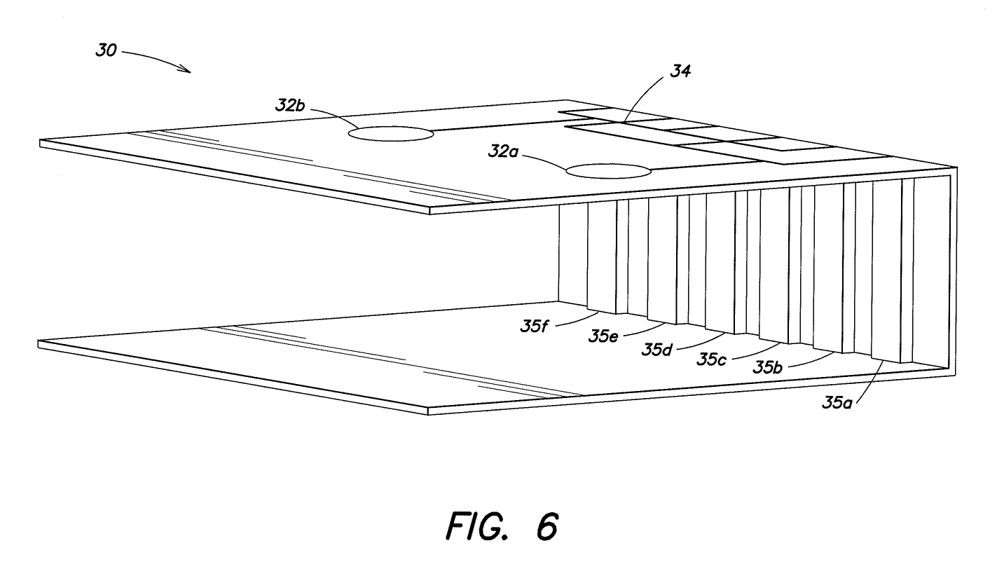

FIGS. 5 and 6 illustrate a terminal adapter 30 according to some embodiments of the present invention. The terminal adapter 30 is in some examples formed from a flexible material such as plastic. In some examples, the terminal adapter 30 comprises circuitry which in use, electrically connects the power contacts 13a-13f of the portable electronic device 10 to electrical terminals of an alternative power source module 40. The terminal adapter 30 may comprise a plastic film substrate that is molded to fit and contact a battery 20 on an upper side 21, a lower side, and a power terminal end side 25. Alternate examples of the terminal adapter 30 may comprise a plastic film substrate that is molded to fit and contact a battery 20 on an upper side 21, and a power terminal end side 25 only. Alternate examples of the terminal adapter 30 may include circuitry on one or on two sides thereof.

The terminal adapter 30 may include a contact adhesive on a bottom internal face 31a that may be supplied covered by a protective layer of wax paper 37 or other protective film with a pull tab 37a at a corner thereof. As part of a process of installing the terminal adapter 30 into a portable electronic device 10, an end user may remove the protective film to expose the contact surface of the bottom internal face 31a of the terminal adapter 30. Once the contact adhesive is exposed, the terminal adapter 30 may be mounted around an upper side 21, a lower side, and a power terminal end side 25 of a housing of a battery 20. The contact adhesive may be attached via pressure and serve to hold the terminal adapter 30 firmly on the battery 20 of the portable electronic device 10.

Protruding inner terminals 35a-35f of the terminal adapter 30 may make electrical contact with the terminals 23a-23f of battery 20. In alternate examples, the inner terminals 35a-35f may be formed flush on a surface of the terminal adapter 30, and in further examples, the inner terminals 35a-35f may be formed recessed into a surface of the terminal adapter 30. Once the terminal adapter 30 is installed on the battery 20, the external terminals 33a-33f on the terminal adapter 30 may make electrical contact with the battery power terminals 13a-13f of the portable electronic device 10 upon insertion of the battery 20 into the battery compartment 12. In alternate examples, the external terminals 33a-33f may be formed flush on a surface of the terminal adapter 30 and in further examples, the external terminals 33a-33f may be formed protruding from a surface of the terminal adapter 30. In some examples, the inner terminals 35a-35f are in electrical communication with the external terminals 33a-33f of the terminal adapter 30. In some examples, the terminal adapter may have more or fewer inner and/or external terminals than are illustrated in the figures. In some examples, the terminal adapter may have inner and/or external terminals in different shapes or locations than are illustrated in the figures.

The terminal adapter 30 may contain integrated circuit paths 34 made of a conductive material that may form an electrical connection between terminals of an alternative power supply 40 and the protruding external terminals 33a-33f and internal terminals 35a-35f of the terminal adapter 30. Here, the term “integrated circuit path” is meant to mean an electrically conductive element integrated into or onto the material of the terminal adapter and is synonymous with “embedded circuit path.” The external terminals 33a-33f and/or the internal terminals 35a-35f may be coated with a conductive adhesive in order to more securely maintain a connection between the battery terminals 23a-23f and the inner terminals 35a-35f and/or the power contacts 13a-13f of the portable electronic device 10 with the external terminals 33a-33f of the terminal adapter 30.

The inner terminals 35a-35f of the terminal adapter 30 may be connected via embedded circuit paths 34 made of conductive material to the positive 32a and negative 32b terminals located on the top face 31 of the terminal adapter 30. In different examples, circuit paths 34 may electrically connect terminal 32a to only a limited number of external terminals 33a-33f and terminal 32b to only a second limited number of external terminals 33a-33f. The positive terminal 32a and the negative terminal 32b may be made of similar conductive material and may be flush with the surface of the substrate of the terminal adapter 30. In other examples, the positive and negative terminals 32a, 32b extend above the surface of the terminal adapter 30, and in some examples comprise springs and/or spring-loaded terminals. Once the terminal adapter 30 is installed onto the battery 20 of the portable electronic device 10, and the battery 20 is installed into the battery compartment 12 of the portable electronic device 10, the positive terminal 32a and the negative terminal 32b face outward from the battery compartment, exposing their conductive surfaces. In alternate examples, more or fewer than one positive and/or one negative terminal may be present on the terminal adaptor.

In some examples, the terminal adapter 30 comprises a plastic insert that has embedded conductive material that inserts between the battery terminals and a side of a battery compartment into which a portable electronic device battery 20, such as a 3.7-volt lithium ion battery, may be installed. In some examples, the terminal adapter 30 is held in place by pressure and in some examples may fold at a 90-degree angle to form two substantially planar faces and to reveal conductive terminals to the face of the battery enclosure 12 including the power contacts of the portable electronic device. When an alternative power source module 40 is slid into position to cover the battery enclosure, spring-tensioned terminals according to some examples of the alternative power source module 40 make contact with the terminal adapter terminals to complete a circuit. In other examples, electrical terminals of the alternative power source module 40 may comprise a portion of conductive material which in alternate examples may be flush with or protrude from a surface of the alternative power source module 40.

In some examples, the terminal adapter 30 is an electrical circuit intermediary that allows the circuitry of a portable electronic device 10 to interface with an alternative power source module 40, which in some examples comprises a charging device including one or more solar cells. The terminal adapter 30 may comprise a molded substrate containing an embedded electrical circuit and protruding electrical contacts. The protruding electrical contacts may be tapered at an angle, increasing in width from one end to another along a face of the terminal adapter 30. The width of the electrical contacts may increase along with elevation along a face of the terminal adapter 30. The increase of the width of the contacts along a face of the terminal adapter 30 may facilitate electrical contact between the exterior electrical contacts of a battery of a portable electronic device and the terminal adapter 30. The tapered design of the contacts of the terminal adapter 30 may facilitate the creation of a static friction that holds the terminal adapter in place via compression when the original battery of a portable electronic device is placed in the original portable electronic device battery cavity. Tapered electrical contacts protruding from a face of a plastic substrate of terminal adapter 30 may extend through the plastic substrate and continue to protrude onto another face, or an underside of the terminal adapter 30. These protruding electrical contacts may terminate on the same vertical axis and may be flat. These flat contacts may be configured to make connection with existing contacts of a portable electronic device. The flat electrical terminals of the terminal adapter 30 may facilitate electrical contact with spring-loaded contacts or terminals of a portable electronic device.

In some examples, the terminal adapter 30 comprises three sides. A horizontally oriented generally planar top side 31 and a horizontally oriented generally planar bottom side 31a of approximately equal dimensions are in some examples connected by a vertical side. The top and bottom sides, in some examples, are curved to facilitate attachment and/or interfacing with a portable electronic device with a battery or battery compartment with a curved surface. The top side of the terminal adapter may have a positive 32a and a negative 32b direct current electrical terminal disposed on an external face thereof. The terminal adapter 30 may include embedded electrical conduits that may follow the contour of the substrate of the terminal adapter 30, terminating at corresponding terminals disposed on the vertical side. The vertical side may include an embedded electrical contact that protrudes through the substrate. On an internal face of the vertical side of the terminal adapter, electrical contacts may extend in the direction of a battery 20 to which the terminal adapter may be secured or held against and may be situated such that when the terminal adapter 30 is attached, these contacts may make a secure electrical connection with the battery of the portable electronic device 10. An external face of the vertical side of the terminal adapter 30 (a side facing away from the battery) may comprise slightly protruding flat electrical contacts. These slightly protruding flat electrical contacts may be in electrical communication with opposing terminals of the terminal adapter via conductive material embedded in the plastic substrate of the terminal adapter, and may be arranged such that, when the terminal adapter 30 is attached to a battery 20 of a portable electronic device 10, they may align to make secure electrical connections with electrical contacts of the portable electronic device. A bottom face of the upper side 31 of the terminal adapter 30 may be coated with an adhesive. This adhesive may facilitate securing the terminal adapter 30 to a casing on a top side 21 of a battery 20 of the portable electronic device 10.

The bottom side 31a of the terminal adapter 30 may be similar to the top side 31, but contain no electrical circuitry. The bottom side may have an upper face that is coated in adhesive. This adhesive may facilitate securing the bottom side to a casing on a bottom side of a battery 20 of the portable electronic device 10.

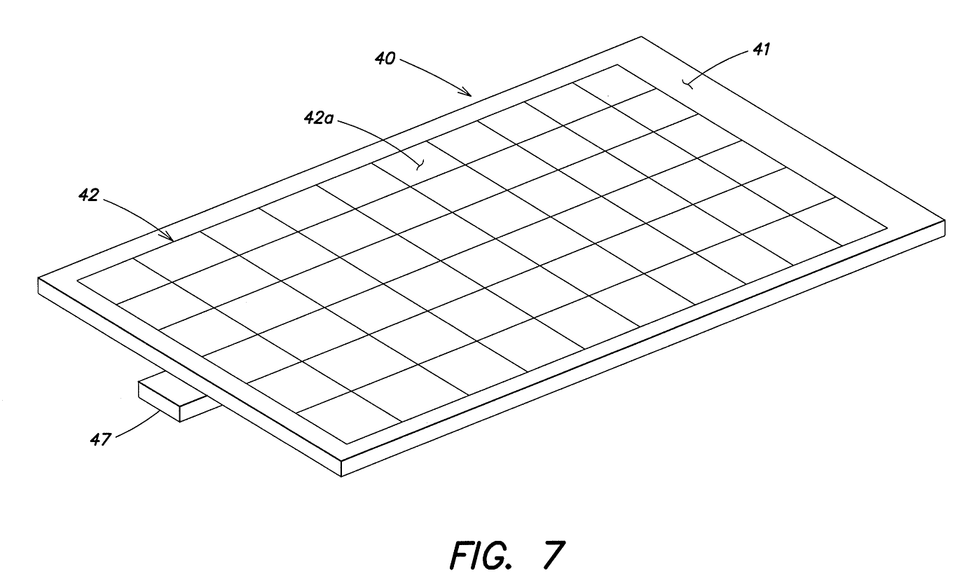

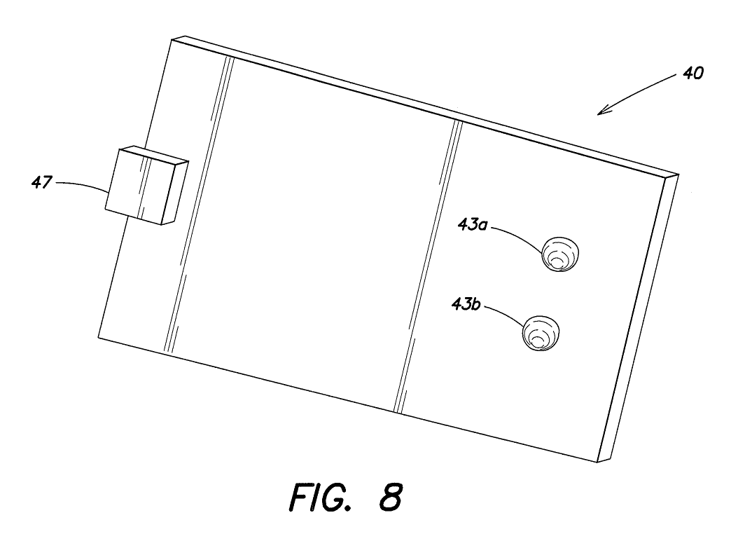

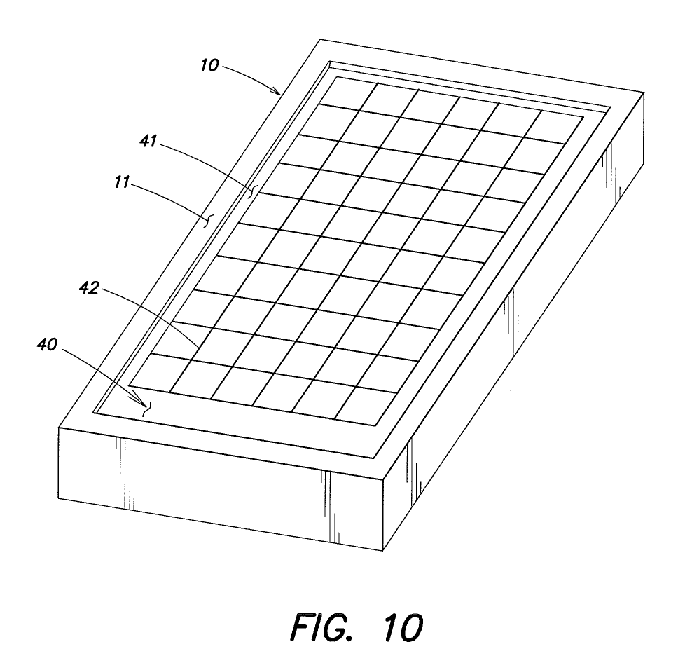

FIGS. 7 and 8 illustrate an alternative power source module 40 according to an example of the present invention. In some examples, the alternative power source 40 comprises an electrical device that is configured to transmit electrical current through the terminal adapter 30 and to the battery 20 of a portable electronic device 10. The alternative power source 40 may comprise plastic or other suitable material in a shape that fits into, onto, or around the portable electronic device 10. In some examples, the alternative power source 40 may be configured as a replacement battery cover for a portable electronic device 10, which when installed, covers a battery compartment cavity 12. In other examples, the alternative power source 40 may be configured as a shell that at least partially encloses portable electronic device 10. The alternative power source 40 may be molded to have side flanges (not shown) that fit into tracks or grooves 15 of the portable electronic device 10. The alternative power source 40 may also have a tab latch 47 that fits into a recess 14 of the portable electronic device body to facilitate holding the alternative power source 40 securely in place on the portable electronic device 10 as is illustrated in FIG. 10. The alternative power source 40 may be sized and shaped substantially similarly to the original battery cover of the portable electronic device which it may replace. In this context, the term “substantially similar” in size and shape is intended to be interpreted to mean that the alternative power source 40 would add less than 5 mm, preferably less than 3 mm, and even more preferably, less than 1 mm, to the thickness or width of a portable electronic device on or in which it is mounted. In some examples, the replacement of an original battery cover with a replacement battery cover incorporating an alternative power source 40 would result in such a minimal, if any, change in the dimensions of the overall device that the dimensions of the device with the alternative power source 40 would be substantially similar to the dimensions of the original device such that a user would be unlikely to recognize the difference. This may also hold true for examples where the alternative power source 40 is mounted to the external body of the portable electronic device.

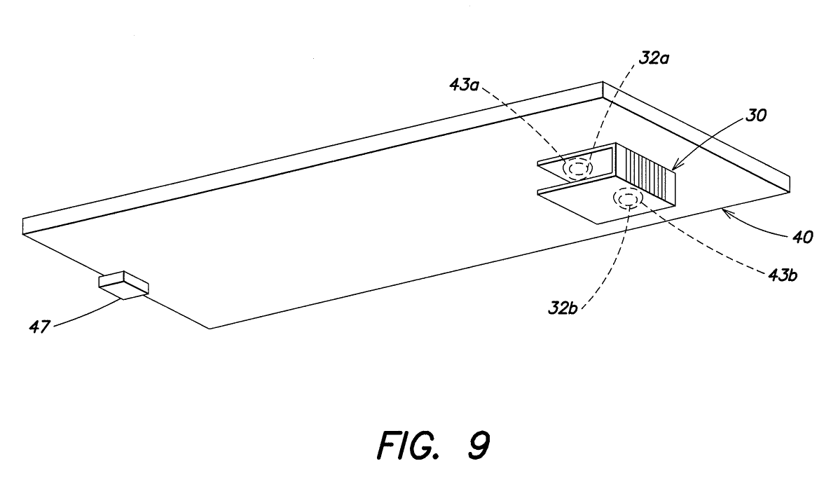

Returning to FIGS. 7 and 8, the illustrated example of alternative power source 40 includes two electrical terminals, a positive terminal 43a and a negative terminal 43b. The positive terminal 43a and the negative terminal 43b comprise a conductive material such as, but not limited to, aluminum. Positive terminal 43a and negative terminal 43b protrude from the bottom face of the alternative power source 40 and may take the form of solid protrusions. In alternate examples, there terminals may be in the form of springs or tabs. In further examples, these terminals may be formed flush against the surface of the body of the alternative power source 40. In even further examples, there terminals may be formed on a protrusion that is configured to fit into a pre-existing power supply input on a portable electronic device 10. When the alternative power source 40 is installed or slid into place onto, into, or about a portable electronic device, the positive terminal 43a and the negative terminal 43b may make contact with a corresponding outward facing positive terminal 32a and negative terminal 32b of a terminal adapter 30 which may have been installed previously in the portable electronic device 10 as is illustrated in FIG. 9 (where the battery 20 and the portable electronic device 10 have been omitted for clarity). The designations of positive and negative polarities for terminals 43a, 43b, 32a, and 32b is not meant to be limiting, but is provided for ease of description. For example, in alternate examples, terminal 43a may be a negative terminal and terminal 43b may be a positive terminal.

In some examples, the alternative power source 40 comprises a replacement battery cover for a portable electronic device that produces electricity by the conversion of light to electricity (photovoltaics) to charge an internal battery of the portable electronic device.

A replacement battery cover according to some examples comprises molded plastic such as ABS molded plastic and may comprise slotted side edges configured to follow recessed track lines in a battery compartment of a portable electronic device. The cover may also comprise a tab-like protrusion 47 on its leading edge that may latch into a recess in the outer body of the portable electronic device to facilitate holding the replacement battery cover in place.

The back face of an example of the replacement battery cover may house a solar cell or a plurality of solar cells 42, 42a, for example, a 4.8 volt photovoltaic solar panel as illustrated in FIG. 7. In some examples, the solar cell or cells are secured on the back face of a molded plastic shell and covered by a protective clear resin or plastic material. The solar panel may have electrical terminals that begin at the end of the solar panels' electrical circuit and terminate on a side of the replacement battery cover. The replacement battery cover may comprise a diode, such as a 5-volt zener or blocking diode connected in line with a positive and/or a negative terminal of the solar panel. The replacement battery cover may comprise spring tensioned gold plated terminal connectors. These connectors may make electrical contact with a terminal adapter mounted within a portable electronic device when the replacement battery cover is installed on the portable electronic device.

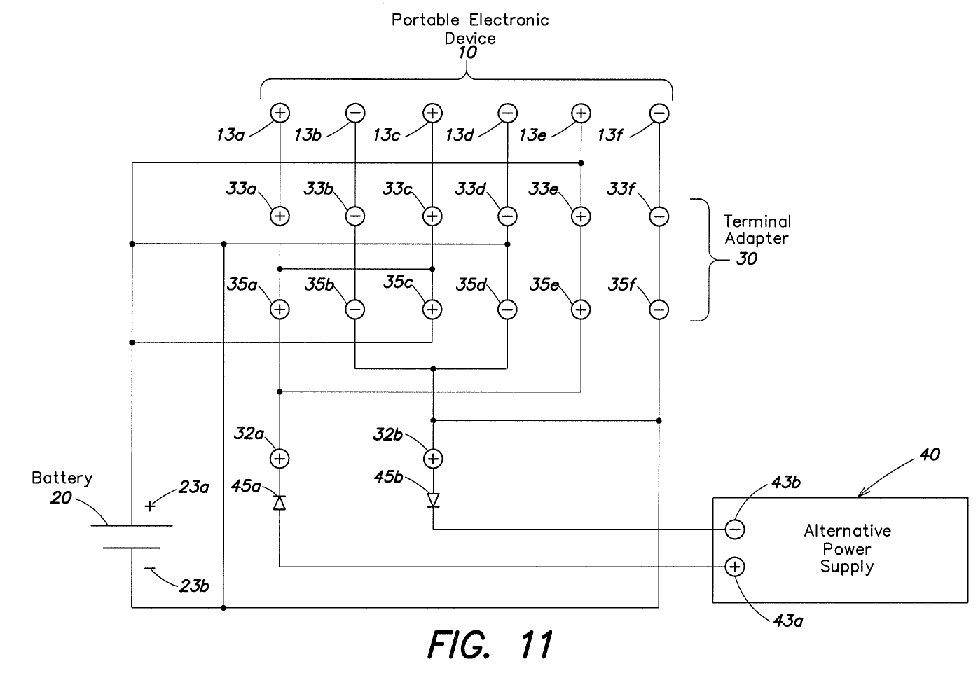

A positive power output of the power generator of the alternative power source 40 may be connected via an integrated circuit path made of embedded conductive material through a blocking diode 45a embedded within the body of the alternative power source 40 to the positive terminal 43a. This blocking diode 45a may in some embodiments be formed in the terminal adapter 30, as illustrated schematically in FIG. 11. The blocking diode 45a may prevent or reduce the likelihood that the alternative power source 40 may extract electrical power from the portable electronic device battery 20. The blocking diode 45a permits current to flow in a single direction, from the alternative power source 40 into the terminal adapter 30 and to the battery 20. In some examples, a charge controller, and/or potentiometer, and/or voltage regulator may be installed into an electrical circuit which may include the blocking diode 45a and the positive terminal 43a of the alternative power source 40. This charge controller may regulate the flow of current from the alternative power source 40 and through the terminal adapter 30 and into the battery 20. A negative power terminal of the alternative power source 40 may be connected via an integrated circuit path made of embedded conductive material to a negative terminal of the power generator of alternative power source 40. A second blocking diode 45b to control the direction of flow of current in this circuit path may be provided either in the alternative power source 40 or the terminal adapter 30. In some examples a small leakage current may flow from the portable electronic device battery 20 to the alternative power source 40.

In some examples, a portable electronic device with a terminal adapter and alternative power source 40 installed may still be charged by a charging device such as a power adapter that may be utilized to charge the battery of the device in the absence of the addition of the terminal adapter and alternative power source 40.

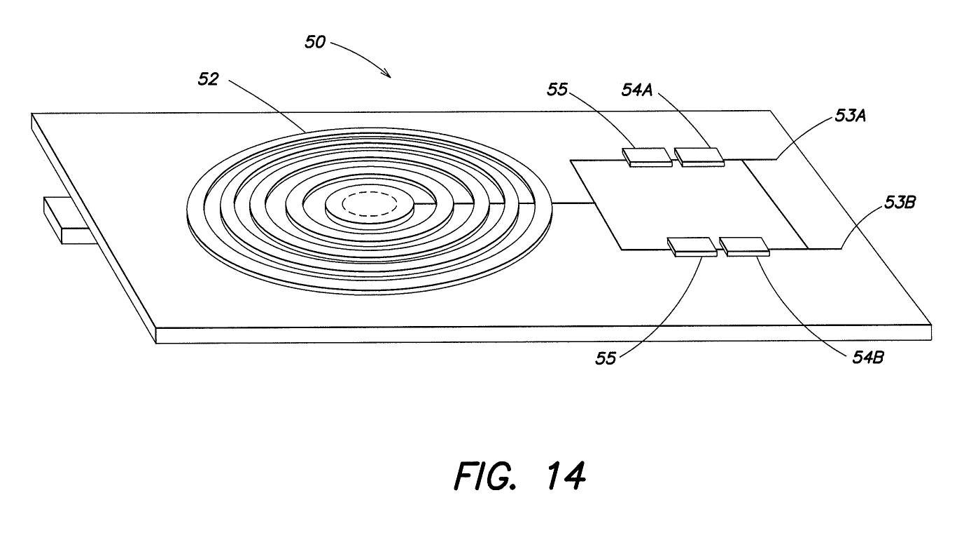

Alternate examples of an alternative power source 40 may comprise a solar power generator 42, 42a as illustrated in FIG. 7, an RF energy capture device 52 as illustrated in FIG. 14, or another form of power generator or energy conversion device. The top face of the alternative power source 40 may comprise, for example, a photovoltaic panel 42 (a solar panel) that is mounted on the housing or substrate 41 of the alternative power source 40. The solar panel 42 may be covered by a clear protective layer in order to shield the surface of the photovoltaic panel from damage. The solar photovoltaic panel may have a positive terminal and a negative terminal. In some examples, the photovoltaic panel may have multiple positive and negative electrical terminals. In some examples, a positive terminal may be electrically connected via an integrated circuit path to a blocking diode 45a, which may in some examples be located on the underside of the alternative power source 40. In some examples, the blocking diode 45a may be omitted or may be located in a different area, such as in the terminal adapter, embedded in the material of the alternative power source, or on a surface of the terminal adapter or alternative power source. Similarly, a negative terminal of the photovoltaic panel may be connected via an integrated circuit path to the negative terminal 43b on the underside of the alternative power source 40. A battery or other energy storage device, such as a capacitor, may also be integrated into, or connected to, the body of the alternative power source 40.

In use, when apparatus according to some examples comprising the terminal adapter 30 and the alternative power source 40, is installed and connected to the battery 20 and a portable electronic device 10, the alternative power source 40 may provide electrical current to charge the battery 20 of the portable electronic device 10. To charge the battery of the portable electronic device 10, electrical current is transmitted from the power source (e.g. solar photovoltaic panel 42) of the alternative power source 40. In some examples, electrical current is transmitted from the power source terminals though embedded circuitry and passes through optional blocking diode or diodes 45a, 45b into terminals 43a and 43b on the alternative power source 40. In some examples, the electrical current travels from terminals 43a and 43b on the alternative power source 40 into terminals 32a and 32b on a surface such as the top face of the terminal adapter 30. The current may travel from the terminals 32a and 32b, through the embedded circuit paths 34 and into the inner facing terminals 35a-35f of the terminal adapter. The terminals 35a-35f may transmit the current to terminals 23a-23f located on the battery 20 of the portable electronic device 10.

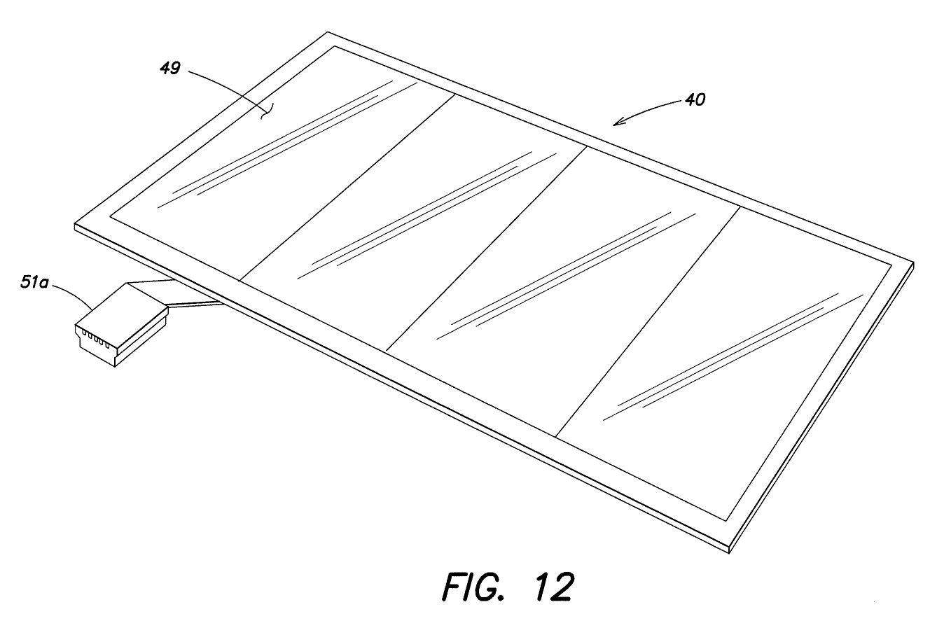

In an alternate example, as illustrated in FIG. 12, the alternative power supply 40 is in the form of a thin substrate comprising an electrical current generator, such as a solar cell or cells 49 on an external face, and an adhesive backing on an internal face. The substrate is on some examples rigid, and in some examples, flexible. The electrical current generator in some examples also comprises a flexible material. The alternative power supply 40 may be adhered to a surface of a portable electronic device. Electrical contact between the alternative power supply 40 and a battery 20 of a portable electronic device may be made by, for example, providing a ribbon cable in electrical communication with the alternative power supply 40 extending through or around a battery cover of the portable electronic device and making electrical contact with a terminal adapter 30 mounted on a battery 20 of the portable electronic device 10 as described above. Alternatively, electrical contact between the alternative power supply 40 and a battery 20 of a portable electronic device 10 may be made through a ribbon cable in electrical communication with the alternative power supply 40 which terminates in a mini-USB terminal 51a which may interface with a mini-USB port 51b of the portable electronic device.

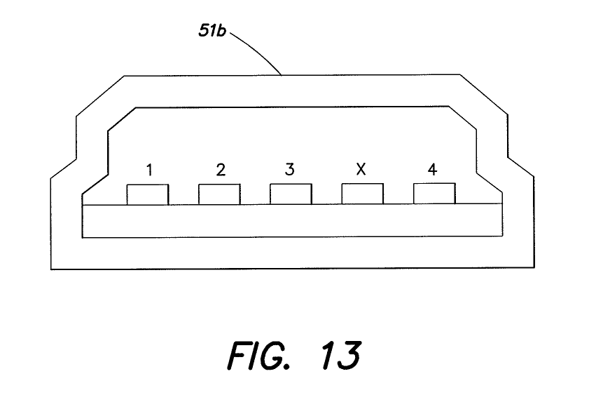

FIG. 13 is a diagram a mini-USB port 51b that may be present on some portable electronic devices. In alternate examples of portable electronic devices with such a mini-USB port, the mini-USB port 51b may be in one of a male or a female configuration. In one example, there are five terminals or pins with the functionality described in the table below. In some examples, power output terminals from an alternative power supply 40, such as that illustrated in FIG. 12, would be configured to make electrical contact with pins 1 and 4 by way of a cable and mini-USB connector.

| Pin | Name | Cable color | Description |
|---|---|---|---|
| 1 | VCC | Red | +5 VDC |
| 2 | D− | White | Data− |
| 3 | D+ | Green | Data+ |
| X | ID | | May be N/C, GND or used as an |
| | | | attached device presence indicator |
| | | | (shorted to GND with resistor) |
| 4 | GND | Black | Ground |

The alternative power source 40 is to be understood as not limited to utilizing solar or light energy for power generation. Alternate examples of the alternative power source 40 may generate power from other mechanisms such as a fuel cell, ambient RF power capture, mechanical hand cranks, mechanical motion, static electricity collection, microwave radiation collection, and/or wind power collection.

For example, FIG. 14 illustrates an alternative power source module according to an additional example where the alternative power source 50 comprises a wireless power receiver. The wireless power receiver may be composed of integrated circuitry that includes an antenna 52 connected to components such as control components 55, diodes 54A and 54B, and associated circuitry. This circuitry terminates at two separate terminals, a positive terminal 53A and a negative terminal 53B which may electrically connect to terminals on the underside of the alternative power source 50, which may be similar to terminals 43a and 43b illustrated in FIG. 8 and as described above. The alternative power source 50 may in some examples be of a similar shape and size as the alternative power source 40 described above.

The antenna 52 may receive energy in the form of electromagnetic radiation such as microwaves or radio waves. The source of this energy may be ambient electromagnetic radiation in the environment. The antenna may receive this energy, which may be converted to direct electric current by the integrated components 55. The direct current may then be transmitted through the charge controller components which may comprise, but are not limited to, diodes 54A and 54B and other associated components 55. The direct current then may travel to the positive and negative terminals on the underside of the device (not shown). When installed on a portable electronic device equipped with a terminal adapter, the alternative power source terminals 53A and 53B may contact the terminals of the terminal adapter via electrical terminals on the lower side of alternative power source 50 to deliver power to the portable electronic device.

In use, when an apparatus according to an example of the present invention comprising a terminal adapter 30 and an alternative power source 50, is installed and connected to a battery 20 and a portable electronic device 10, the alternative power source 50 may provide electrical current to charge the battery 20 of the portable electronic device 10.

The antenna 52 may be replaced and/or supplemented by a power receiver to allow for wireless power reception from alternate sources utilizing alternate methodologies, such as, for example, inductive coupling, resonant induction, or evanescent wave coupling. Additional components may be added and/or substituted, and some components may be removed from the internal circuitry of the alternative power source as illustrated to enable wireless power capture. In alternate examples, any or all of components 52, 53A, 53B, 54A, 54b, and 55 may be positioned internal to the body of alternative power supply 50 or on an underside rather than a top side or alternative power supply 50.

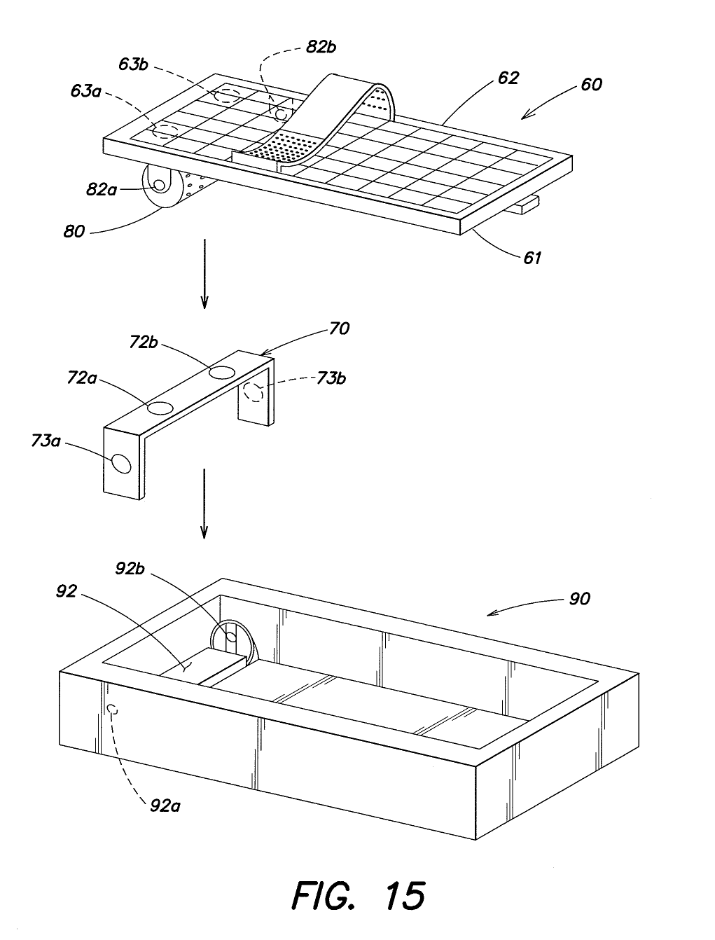

FIG. 15 illustrates a further alternate example of the present invention. This figure depicts an alternate portable electronic device 90, for example, a garage door remote, which may be powered by an alternative power source 60 comprising, for example, a photovoltaic panel.

In use, when apparatus according to some examples of the present invention, comprising a terminal adapter 70 and an alternative power source 60, is installed and connected to a battery 80 and a portable electronic device 90, the alternative power source 60 may provide electrical current to charge the battery 80 of the portable electronic device 90.

In some embodiments, the alternative power source 60 may comprise plastic or other suitable material 61 in a shape that fits into the portable electronic device 90, and which when installed, covers the battery compartment cavity 92. The alternative power source 60 may be molded to fit into, onto, or around the body of the portable electronic device.

The alternative power source 60 may comprise a replacement battery cover 62. The back face of the replacement battery cover 62 may house a power generator such as a photovoltaic cell or a plurality of photovoltaic cells that may be secured to the back face of the molded plastic and in some examples covered by a transparent protective material. The photovoltaic panel may have two electrical terminals that begin at the end of the photovoltaic panel's circuit and terminate on a bottom side of the replacement cover. The replacement battery cover may contain integrated circuitry such as diodes and current and voltage control devices. The replacement cover in some examples comprises terminals, and in some examples, gold-plated terminals, that may be configured to make electrical contact with the terminal adapter 70.

The alternative power source 60 may have two electrical terminals, positive terminal 63a and negative terminal 63b. The polarities of these terminals are not intended to be limiting and are provided for ease of description only. These terminals may comprise a conductive material such as, but not limited to, aluminum. The positive terminal 63a and the negative terminal 63b may protrude from the bottom face of the alternative power source 60 in a similar manner as is illustrated on the embodiment shown in FIG. 8 and as described with reference to this figure above. When the alternative power source 60 is installed or slid into place on portable electronic device 90, the positive terminal 63a and the negative terminal 63b may make contact with a corresponding outward facing positive terminal 72a and negative terminal 72b of a terminal adapter 70 which may have been installed previously in the portable electronic device 90.

The terminal adapter may be fitted between the circuit terminals of the portable electronic device 90 and the battery 80. Terminal 73a of the terminal adapter, when the terminal adapter is installed, may electrically connect to the terminal 82a of the battery 80, as well as to the terminal 92a of the portable electronic device 90. Terminal 73b of the terminal adapter also may electrically connect to the terminal 82b of the battery 80, as well as the terminal 92b of the portable electronic device 90. Portions of the terminal adapter 70 including the electrical contacts 73a, 73b may be sandwiched between the battery 80 and the battery contacts 92a and 92b. When the alternative power source 60 is slid into place, the terminal 72a of the terminal adapter 70 may make electrical contact with the terminal 63a of the alternative power source 60. Similarly, the terminal 72b of the terminal adapter 70 may make electrical contact with the terminal 63b of the alternative power source 60.

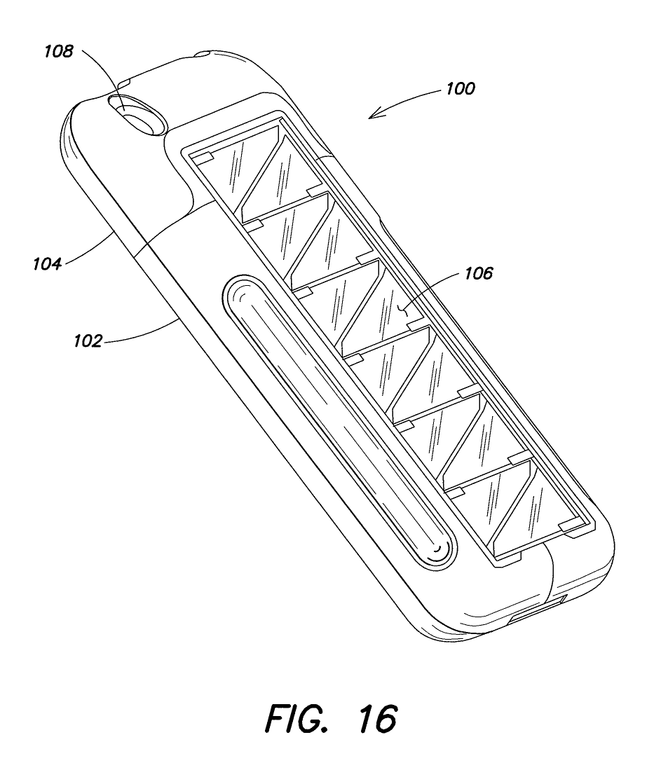

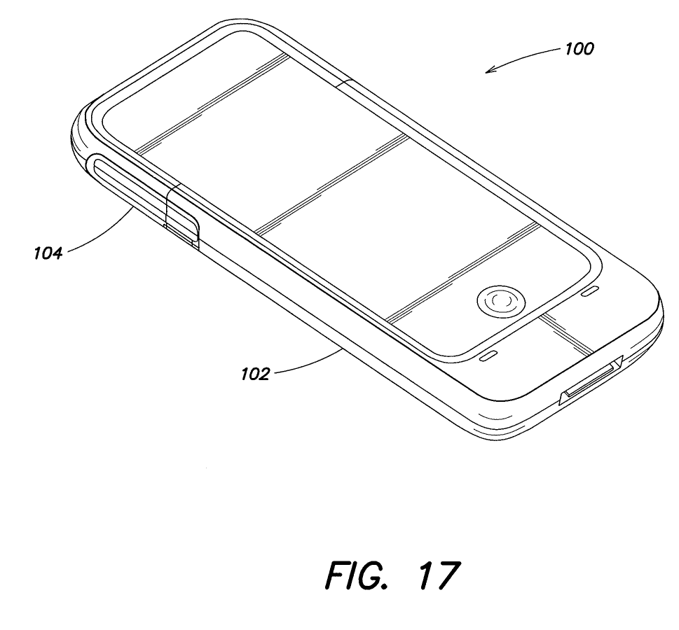

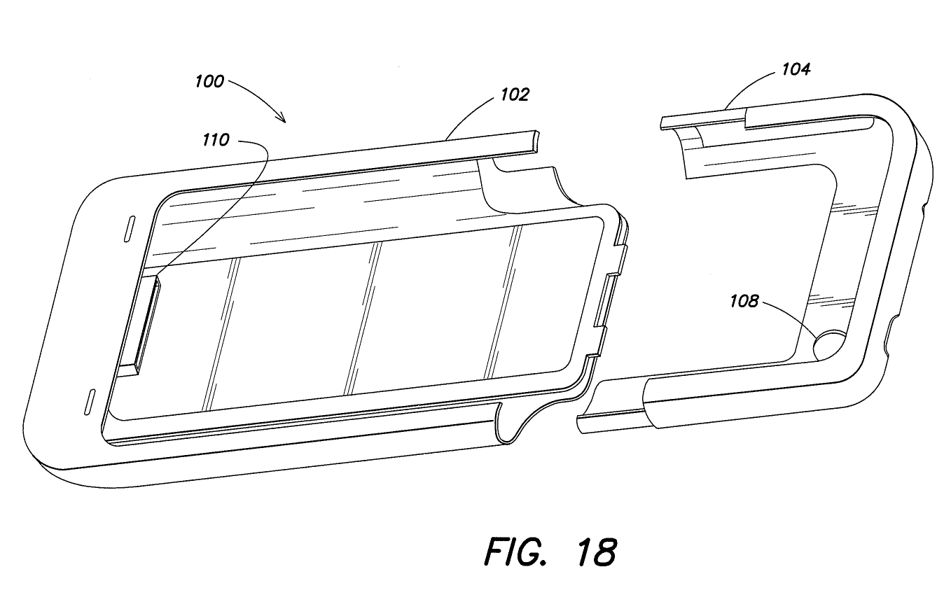

In a further alternate example, illustrated in FIGS. 16-18, the alternative power source includes a housing 100 or shell that substantially encloses a portable electronic device. For example, the housing may be a form fitting casing that fits around part or the entirety of the portable electronic device. The housing or shell 100 may include an alternative power generation device, such as a plurality of solar cells 106 on at least one surface thereof. Holes and/or transparent sections 108 may be included in the casing to allow a user to view and/or operate functional portions of the device. For example, in a cell phone with a camera, a hole or flexible sheeting may be provided over the phone keyboard, a transparent section or opening may be provided over the screen of the cell phone, openings may be provided for the microphone and speaker elements, and a hole or transparent section may be provided over the lens of the camera. In some examples this casing may comprise two or more (e.g., a plurality of) sections 102, 104 that may be separated by a user to insert or remove the portable electronic device. In other embodiments, the shell or casing 100 may include a flexible portion comprised of a material such as a flexible polymer that may allow the insertion or removal of a portable electronic device. The shell or casing may include terminals for making contact with a terminal adapter as described with regard to FIGS. 5-9 above. In some examples, the shell or casing 100 including the alternative power source may include a protrusion 110 configured to mate with or be inserted into a pre-existing power supply slot in a portable electronic device.

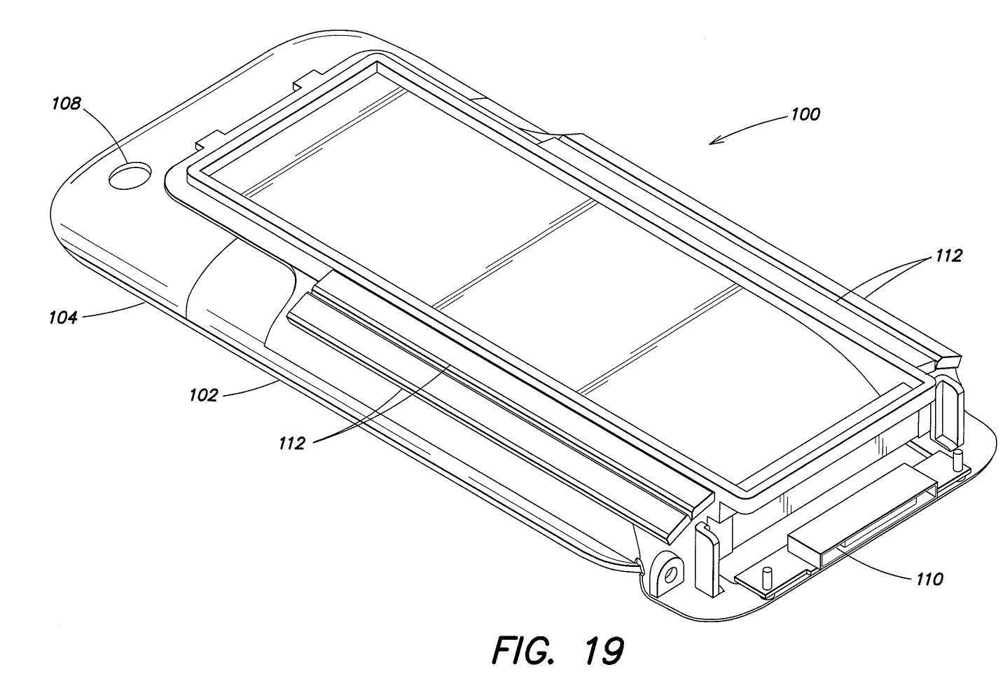

The alternative power source 40, 50, 60, 100, in some examples, comprises an energy storage device such as a capacitor or a battery. FIGS. 19-23 illustrate different configurations of energy storage devices which may be present in different examples of an alternative power source in accordance with the present disclosure. FIGS. 19-23 illustrate examples of alternative power sources comprising casings similar to that of FIGS. 16-19, cut away to show the placement and configuration of different examples of energy storage devices that may be included therein. Electrical contacts and wiring for these energy storage devices have been omitted from the figures for clarity.

FIG. 19 illustrates energy storage devices 112 which are in the form of rectangular blocks. One or more of these energy storage blocks 112 may be mounted on or within a body or casing of an alternative power supply and electrically coupled to one or more electrical terminals of the alternative power supply and a source of electrical power and/or to a battery of a portable electronic device. The energy storage blocks 112 may comprise batteries or capacitors a combination of one or more batteries and capacitors.

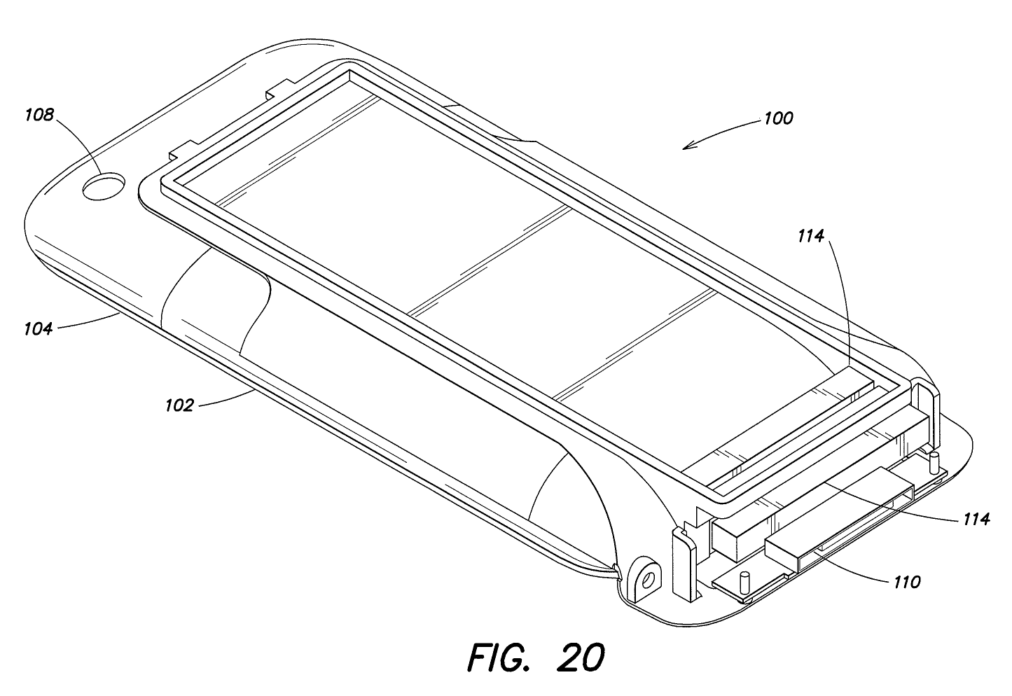

FIG. 20 illustrates an example energy storage device 114 which is in the form of a rectangular block. This energy storage block 114 may be mounted on or within a body or casing of an alternative power supply and electrically coupled to one or more electrical terminals of the alternative power supply and a source of electrical power and/or to a battery of a portable electronic device. One or more of energy storage blocks 114 may be present in different examples. In different examples, the energy storage block 114 may comprise a battery or a capacitor or a plurality of batteries and/or capacitors.

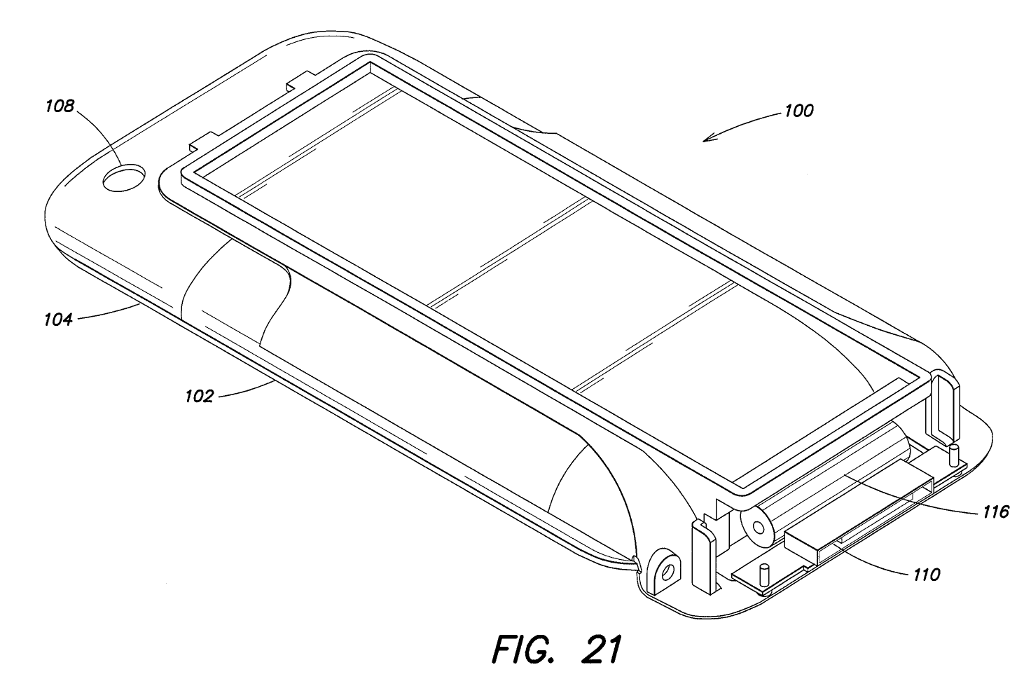

FIG. 21 illustrates an example energy storage device 116 which is in the form of a cylinder. This energy storage cylinder 116 may be mounted on or within a body or casing of an alternative power supply and electrically coupled to one or more electrical terminals of the alternative power supply and a source of electrical power and/or to a battery of a portable electronic device. In different examples, the energy storage cylinder 116 may comprise a battery (for example, a rechargeable AA, AAA, or AAAA battery), a capacitor, or a combination of one or more batteries and capacitors.

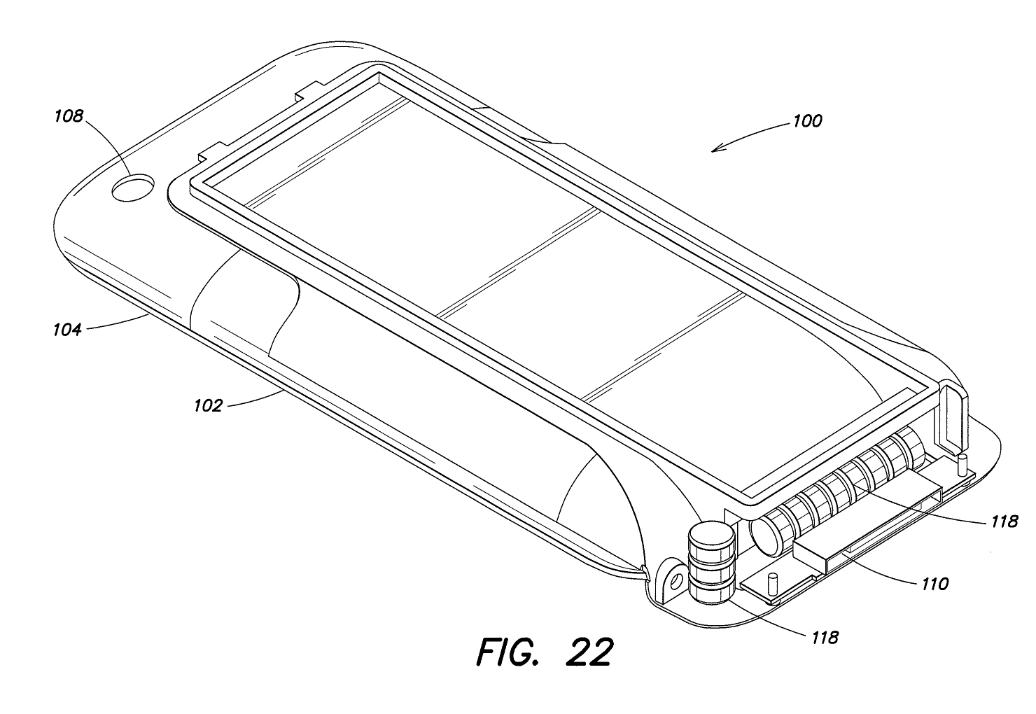

FIG. 22 illustrates an example energy storage device 118 which is in the form of a plurality of disks. The energy storage disks 118 may be mounted on or within a body or casing of an alternative power supply and electrically coupled to one or more electrical terminals of the alternative power supply and a source of electrical power and/or to a battery of a portable electronic device. The disks may be stacked in a horizontal configuration and/or a vertical configuration as illustrated. In some examples, both a vertical and a horizontal stack of energy storage disks 118 may be present. In other examples a single vertical or a single horizontal stack may be present. In different examples, the energy storage disks 118 may comprise batteries (for example, button cell or hearing aid batteries), capacitors, or a combination of batteries and capacitors.

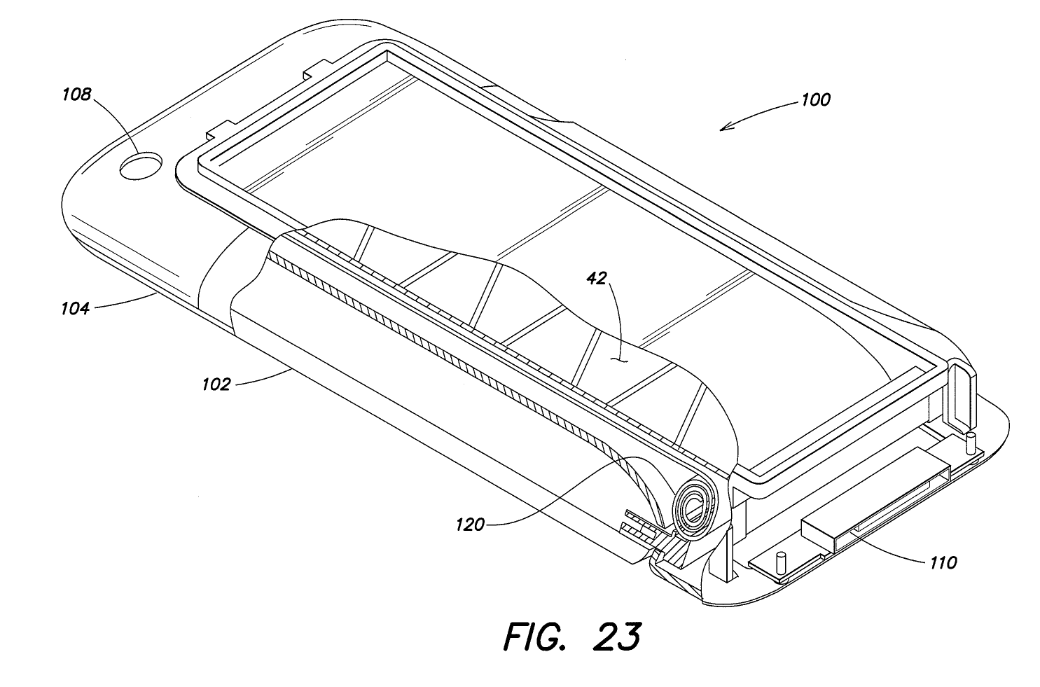

FIG. 23 illustrates an example energy storage device 120 which is in the form of a film. In some examples, this energy storage film is flexible and may include a portion that is folded or rolled as illustrated in FIG. 23. This energy storage film 120 may be mounted on or within a body or casing of an alternative power supply and electrically coupled to one or more electrical terminals of the alternative power supply and a source of electrical power and/or to a battery of a portable electronic device. In different examples, the energy storage film may comprise one or more batteries (for example, a thin film polymer battery), a capacitor, or a combination of batteries and capacitors.

The battery or batteries that may be present in any of the examples of the alternative power supplies described above are not limited to any particular type of battery. For example different examples may include NiCd batteries, Li-ion batteries, NiMH batteries, polymer batteries, or any other type of battery or batteries suitable for the particular example.

The alternative power source 40, 50, 60, 100, in some examples comprises an USB port for power input, which may facilitate powering or charging of a portable electronic device by a USB cable through which power is supplied from, for example, a portable computer.

In alternate examples, the alternative power source may be replaced with a device other than one which supplies power. For example, devices comprising GPS tracking systems, video displays, lights, etc. may take the place of alternative power supply in any of the examples of the present invention as described above.

### Prophetic Example:

Outdoors, in direct sunlight, a portable electronic device may be exposed to solar energy intensities of up to about 1,000 W/m² but indoors, under artificial desktop lighting or outdoors during overcast weather, the energy intensity may decreases to about 100 W/m².

Many cell phone batteries comprise 3.7 volt lithium ion batteries.

These batteries may range in capacity from 500-2000 mAH (milli Amp Hours).

For example, a Blackberry™ 8830 smartphone utilizes a 3.7 volt lithium ion battery rated for 1200 mAH. The capacity of the battery is approximately 4.44 watt/hours total.

The back battery panel of a Blackberry™ 8830 smartphone is 2 inches by 2.4 inches (4.8 in²). A conveniently usable area on the rear side of the phone is 4.5 by 2.6 inches (11.7 in²). The following numbers illustrate a total time required to fully charge a battery of a Blackberry™ 8830 smartphone assuming the use of only a replacement battery cover comprising a solar power generator. If using the entire back of the phone, the below numbers could be doubled.

| | | | Phone | |
|---|---|---|---|---|
| Technology | Efficiency | Voltage and Current | Charge Time | |
| Thin film laminate | Up to 8% | 4.8 V at 40 mA | 24 | hours |
| Monocrystaline cells | Up to 14% | 4.8 V at 80 mA | 12 | hours |
| Multicrystaline cells | Up to 28% | 4.8 volts at 150 mA | 8 | hours |
| New technologies, e.g. | Up to 45% | 4.8 volts at 250 mA | 4.8 | hours |
| nanosolar cells | | | | |

Thus, a device according to examples of the present invention could fully charge a cell phone battery in as little as 4.8 hours, or even less as more efficient photovoltaic materials are developed and utilized. Of course, it is to be appreciated that intermittent exposure to light could provide power to recharge a battery on a periodic basis, and may extend a charge of a battery rather than recharge it fully.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. (canceled)

2. (canceled)

3. A system for providing supplemental power to a portable electronic device comprising:
a terminal adapter constructed and arranged to be in electrical communication with terminals of a battery of the portable electronic device and with power terminals of the portable electronic device; and
a power generation device constructed and arranged to be in electrical communication with the terminal adapter, the power generation device configured to be coupled to a battery cover of the portable electronic device,
wherein the terminal adapter is constructed and arranged to be mounted on the battery of the portable electronic device and enclosed in a battery compartment of the portable electronic device,
and wherein the power generation device is constructed and arranged to be connected to the portable electronic device external to the battery compartment of the portable electronic device.

4. The system of claim 3, wherein the power generation device comprises a solar cell.

5. The system of claim 3, wherein the power generation device comprises a radio frequency energy collector.

6. The system of claim 3, wherein the power generation device comprises a mechanical energy to electrical energy converter.

7. The system of claim 3, wherein the power generation device is formed within a battery compartment cover.

8. The system of claim 7, wherein the battery compartment cover is configured to replace a non-enhanced battery compartment cover while substantially maintaining the dimensions of the portable electronic device as measured when fitted with the non-enhanced battery compartment cover.

9. The system of claim 7, wherein electrical contacts of the battery compartment cover comprise electrical terminals constructed and arranged to interface with electrical terminals of the terminal adapter.

10. The system of claim 3, wherein the power generation device is incorporated into a component of substantially similar size and shape as a component of a portable electronic device.

11. The system of claim 3, wherein the battery is configured to be charged by both the power generation device and by a charging means configured to charge the battery of the portable electronic device in the absence of the terminal adapter and power generation device.

12. The system of claim 3, wherein the power generation device comprises a supplemental energy storage device.

13. The system of claim 12, wherein the supplemental energy storage device is configured to be charged by a charging means configured to charge the battery of the portable electronic device in the absence of the terminal adapter and power generation device.

14. A method of providing supplemental power to a portable electronic device comprising:
providing a system for providing supplemental power to a portable electronic device, the system including
a terminal adapter constructed and arranged to be in electrical communication with terminals of a battery of the portable electronic device and with power terminals of the portable electronic device; and
a power generation device constructed and arranged to be in electrical communication with the terminal adapter, the power generation device coupled to a battery cover of the portable electronic device,
wherein the terminal adapter is constructed and arranged to be mounted on the battery of the portable electronic device and enclosed in a battery compartment of the portable electronic device,
and wherein the power generation device is constructed and arranged to be connected to the portable electronic device external to the battery compartment of the portable electronic device;
mounting the terminal adapter to the battery of the portable electronic device; wherein a first set of electrical terminals of the terminal adapter makes electrical contact with power terminals of the battery and positive terminal and negative terminals of the terminal adapter are positioned on a side of the terminal adapter opposite the battery;
installing the battery into a battery compartment of the portable electronic device, such that a second set of electrical terminals of the terminal adapter make electrical contact with power terminals of the portable electronic device; and
mounting the battery cover comprising positive and negative electrical contacts on the battery compartment of the portable electronic device, the positive and negative electrical contacts of the battery cover making electrical contact with outward facing positive and negative terminals of the terminal adapter.

15. The system of claim 3, wherein the terminal adaptor comprises:
a substrate;
a first surface comprising a plurality of power contacts;
a second surface comprising a positive electrical contact and a negative electrical contact; and
an electrical conductor bound to the substrate and electrically connecting the positive electrical contact to at least one of the plurality of power contacts and electrically connecting the negative electrical contact to at least one other of the plurality of power contacts.

16. The device of claim 15, wherein the first surface is joined to the second surface at an approximately ninety degree angle.

17. The apparatus of claim 3, wherein the power generation device comprises:
a flexible substrate, the substrate comprising an adhesive layer on a first side of the substrate; and
a flexible power generation device joined to a second side of the substrate.

18. An apparatus for providing supplemental power to a portable electronic device comprising:
a body distinct from a body of the potable electronic device;
a solar cell mounted to the body; and
an electrical circuit electrically connecting the solar cell to an electrical contact, the electrical contact configured to electrically connect to a power terminal of the portable electronic device,
wherein the body defines a cavity configured to secure the portable electronic device, and wherein the body defines a hole through which a control of the portable electronic device is accessible.

19. The apparatus of claim 17, wherein the flexible power generation device comprises a flexible photovoltaic device.

20. The apparatus of claim 18, wherein the body further comprises an energy storage device.

21. The apparatus of claim 20, wherein the energy storage device is configured to be charged by a charger configured to charge a battery of the portable electronic.

22. The apparatus of claim 18, wherein the body includes a plurality of portions which when joined together define the cavity.

23. The apparatus of claim 18, wherein the body comprises a flexible portion configured to facilitate insertion and removal of the portable electronic device therefrom.
